(19) United States
(12) Patent Application Publication
(10) Pub. No.: US 2003/0108179 A1
(43) Pub. Date: Jun. 12, 2003

(54) System and method for AIN SSP and SCP to support differentiated telecommunications services using a multi-function service node

(76) Inventors: Hwey Chang, Marlboro Township, NJ (US); Pamela Lilly DeFazio, Ocean, NJ (US); Romel R. Khan, Eatontown, NJ (US); Gary A. Munson, Little Silver, NJ (US); Gautham Natarajan, Marlboro Township, NJ (US)

Correspondence Address: Samuel H. Dworetsky, AT&T CORP., P.O. Box 4110, Middletown, NJ, 07748-4110, US

(21) Appl. No.: 10/013,739

(22) Filed: Dec. 10, 2001

(51) Int. Cl. H04M 7/00

(52) U.S. Cl. 379/220.01

(57) ABSTRACT

An enhanced intelligent network telephony system includes at least one service nodes (SN) imbued with special routing, message handling and billing capabilities. Using the Extension Parameter in an Analyze-Route message, a service control point (SCP) provides a set of service node parameters including service node identification and message content. The SN receives, processes and implements the services corresponding to the message content. Included among these may be announcement IDs corresponding to announcements, such as advertisements, that the SN can initiate at an intelligent peripheral for playing to calling and called parties, and routing numbers which the SN can use to route a particular destination under certain conditions as per the service needs. The SN is also able to request an originating switch to update an Automated Message Accounting (AMA) record created at the originating switch, using information created by the SN.

### RELATED APPLICATIONS

NONE

### TECHNICAL FIELD

The present invention relates generally to Advanced Intelligent Networks (AIN). More particularly, the invention relates to AIN components which provide a variety of non-standard capabilities.

### BACKGROUND OF THE INVENTION

An AIN is a service-independent architectural concept for telecommunication networks. Its objectives include the easy development of new and innovative feature-rich services, reducing the turn-around time for the introduction or modification of these services, reducing developmental costs and introducing more complex network functions by which users can communicate or manage information. U.S. Pat. No. 5,535,263, which is incorporated by reference to the extent necessary to understand the present invention, illustrates how an AIN can be used to enhance services.

One of the main distinguishing features of an AIN architecture with respect to a conventional switching network is that the intelligence or logic for executing value-added services is removed from the switch and is placed in one or more central databases called service control points (SCPs). AIN-capable switches, called service switching points (SSP), contain the functionality for communicating with the SCP. To make certain services more user-friendly, Intelligent Peripherals (IPe) may be provided, and these can be used to record prompts and announcements, provide voice recognition, voice-to-text functionality, and the like. The general AIN architecture also contains Service Nodes (SNs), which may receive calls and provide value-added services.

Value-added service calls can be originated from a local exchange (LE) or the SSP itself. In an AIN, the value-added service calls, or “trigger calls”, are routed to the SSP which then opens a dialog with the SCP to guide the call to completion. The trigger call denotes the occurrence of a special condition which results in the telephone call being handled in a special way.

For certain types of toll calls and certain value-added services for which a subscriber is charged, an automatic message accounting (AMA) system is used to keep track of duration of the calls, accrued charges and other billing information. Typically, the AMA is resident in, or associated with, the SSP.

Typically, to provide special handling for a trigger call, the SSP suspends normal execution of the call, communicates with one or more other network elements to obtain special instructions, and handles the call according to the special instructions. Several types of triggers may be specified in an AIN-equipped switching system. They are classified as Originating Triggers, Mid-Call Triggers and Termination Triggers, depending on whether the special handling of the call is performed based on a triggering event at the time of initiation of a call, during the course of a call, or at the time of termination of a call. An example of an originating trigger is an 800-call trigger. This trigger is also called a Dialed Number trigger (DN trigger). Here, the special handling of the call is triggered by a user dialing the 800-number. In general, such numbers are translated to regular telephone numbers, called Plain Old Telephone Service (POTS) numbers, before they are routed to proper destination points via the traditional methods. Handling an 800-number call within an AIN network is described in detail in U.S. Pat. No. 5,425,090, which is incorporated herein by reference. Other examples of triggers are the Off-hook Immediate trigger (OHI), the Off-hook Delay trigger (OHD) and specific digits string trigger (SDS).

Communication between the different components of an AIN is performed through established protocols known to those skilled in the art. More particularly, communication within an AIN takes place between a host of switching systems, adjunct computer processors and other communicating components equipped with the capability to communicate using an out-of-band signaling method known as Common Channel Signaling (CCS). CCS is configured to carry network control information to and from various elements of the network. The signaling in AIN is described in detail in U.S. Pat. No. 5,247,571, which is incorporated herein by reference. For more information on intelligent telephony networks, see The Intelligent Network Standards: Their Application to Services (Igor Faynberg, Ed., McGraw Hill Series on Telecommunications, November, 1996). The details of the usage of CCS to control and manage a telecommunications network are given in U.S. Pat. Nos. 5,515,427 and 4,277,649, both of which are incorporated herein by reference. An example of the CCS signaling method is CCS No. 7 which is also known as Signaling System 7, or SS7. SS7 is the name given to a suite of layered communication protocols that are used to access telephony databases, establish and maintain telephone calls and for other purposes. The part of the SS7 signaling protocol that is typically used by an AIN-equipped switching system to access telephony databases to obtain special instructions is called the Transaction Capabilities Application Part (TCAP).

FIG. 1 shows a simplified prior art AIN system network 100. Network 100 includes a plurality of end users such as a calling party CP102 and a called party CdP 104. The calling party 102 is connected to an originating switch OES 106, either directly as shown, or via one or more intermediary switches (not shown) owned and operated by a local exchange carrier, interexchange carrier, or perhaps being configured as a privately owned PBX switch, or the like. The called party 104 is connected to a terminating switch TES 108, either directly as shown, or via one or more intermediary switches (not shown), also owned and operated by a local exchange carrier, interexchange carrier, or perhaps being configured as a privately owned PBX switch, or the like. The OES and the TES are usually connected to an end user with normal lines and trunks via protocols, such as Plain Old Telephone Service (POTS), Basic Rate Interface (BRI), and Primary Rate Interface (PRI). As seen in the network 100, an intermediate switch IS 110 may connect the originating switch OES 106 to the terminating switch 108. It should be understood that there may also be additional intermediary switches between the calling party 102 and the called party 104, and that the various switches may be owned and operated by different entities, such as local exchange carriers, interexchange carriers, non-telcos and the like.

When the OES 106 encounters an AIN trigger for an incoming call from the calling party 102, the OES 106 communicates with a Service Control Point (SCP) 112 to operate the requested service. The OES 106 and the SCP 112 may communicate through the SS7 network 114 which typically includes a number of Signal Transfer Points (STPs) (not shown). For voice-type functionality, one or more Intelligent Peripherals (IPe) 116 are connected to one or more of the switches 106, 108, 110, as shown, via a trunk or line 118. Each IPe 116 may include recording equipment for voice, fax and other media and is typically connected to a switch using an ISDN trunk or line via PRI or BRI, or the like. It should also be noted that the IPe and the switch may share the same platform, e.g., the same computer, but with different processes running on that computer. Communication between the OES 106 and IS 110, and the IPe 116, may be done through an AIN GR1129 IPe interface. As is known to those skilled in the art, an AIN GR1129 interface is an interworking between the Transaction Capability Application Part (TCAP) protocol and the Integrated Services Digital Network (ISDN) Q.931 protocol, where the SCP 112 communicates with the IPe 116 through the OES 106 using TCAP, and the IPe 116 communicates with the OES and IS using Q.931. Each of the switches 106, 110 thus interworks TCAP, ISUP and Q.931. Further information about the protocol for dealing with an IPe can be found in the GR-1129-CORE document; specifications for the AIN SSP switch procedures can be found in the GR-1298-CORE document; and information about the protocol between the SSP and the SCP can be found in the GR1299-CORE document, all available from Telcordia (formerly Bellcore).

FIG. 2 shows a generalized flow chart 200 for call handling in an intelligent network using a prior art intelligent peripheral. In step 204, the OES receives a call from a calling party. In step 206, the OES determines that special services are required (e.g., by trigger activation) and so contacts the SCP. In step 208, the SCP returns a message to the OES, the message including such things as routing, billing and service information. In step 210, the OES relays the message to an IS having an associated IPe. In step 212, the IS receives the message, selects a channel to the IPe, relays relevant information from the SCP, and connects the caller with the IPe so they can interact. Results of that interaction are returned by way of the IS and OES to the SCP. Finally, in step 214, the SCP instructs the OES on what to do next with the call—e.g., route it to a number corresponding to a called party, and capture certain AMA-related information.

In current AIN systems, the IPe is essentially treated as a temporary endpoint to interact with the caller as per SCP instructions before the call is routed to some other final destination. IPe and related switch capabilities are correspondingly limited. One limitation with currently deployed Ipe's is that they cannot update AMA records, such as those maintained in an associated SSP. As a result, each IPe must potentially maintain multiple interfaces to be compatible with each end billing system which may be deployed. This increases the cost to the operator of the IPe. Another limitation is that information that is normally sent from the originating switch to the terminating switch, and vice versa, will get stuck at the IPe interface, thereby reducing the applicability of an IPe.

Instead of, or in addition to, involving an IPe on a call, the SCP can decide to send the call to an SN for feature processing. When a call is sent to an SN, the SCP and switches consider the call to have egressed the network; there are no special interactions the SN has with the SCP or network switches. The SN is connected to a host switch typically by the same type of PRI as would be used in ordinary customer premises equipment such as a PBX, and an Analyze_Route message is provided by the SCP to get to it, the same as for ordinary customer premises equipment. Therefore, the SN interactions with the network are even more severely limited than an Ipe's interactions with the network.

### SUMMARY OF THE INVENTION

The present invention extends the concepts of Service Nodes (SNs) and Service Switching Points (SSPs) to permit them to interact in advantageous ways. An SN in accordance with the present invention is characterized by a number of functionalities and capabilities not generally associated with the current concepts of SNs or Ipe's. Included among the extended capabilities of an SN are one or more of the following: (1) transport data from the SCP to the SN transparently through the switch; (2) update billing information in the OES based on request from the SN; (3) escape AIN trigger on a per-call basis for calls originated from SN; (4) use SN for preanswer user network interaction; and (5) allowing information to be passed through the SN and IS between the OES and TES. Some of these capabilities are especially useful when the call is hairpinned through the SN when the ultimate destination of the call is some other called party.

In one aspect, both the calling party number (CPN) and the Automated Number Identification (ANI) can be passed all the way to the called party even when the call is hairpinned through the SN. In this aspect, the host switch must also receive the caller=s ANI from the SN and treat it as the legitimate ANI for this call. This is significant because some PBXs need to receive either the CPN or ANI but both must be passed towards the terminating side on the PBX trunks, because it is not known beforehand whether the PBX needs the CPN or the ANI.

In another aspect, the Jurisdiction Information Parameter (LNP-related) can be passed towards the terminating side, so as to comply with certain regulations.

In yet another aspect, the IS and/or TES can relay information back to the OES via the SN, such as the Location Routing Number for a ported telephone number, or a terminating Access Identifier, which may both be useful for the OES to place in the AMA record that it is creating.

In still another aspect, the SN can receive II/OLI digits from the switches, which may be useful in an application such as pre-paid card calling and knowing that the call originated at a payphone, in order to appropriately decrement the caller=s balance.

In yet another aspect, the SN can request an originating switch to update an Automated Message Accounting (AMA) record created at the originating switch—one AMA record per party being charged—using information created by the SN. This eliminates the need for making multiple AMA records for the same call, which later must be merged at the end billing system. This obviates the need to develop interfaces to end billing systems and permits one to use switches currently equipped with interfaces to end billing systems.

The parameters sent by the service node, called “SNFlexblock” parameters, include a parameter ID for identification, a parameter length, and the content. The content may contain information such as, announcement IDs that the SN can use to play announcements to calling and called parties, and routing numbers that the SN can use to route a particular destination under certain conditions as per the service needs.

### BRIEF DESCRIPTION OF THE DRAWINGS

The present invention can better be understood through the attached figures in which:

FIG. 1 shows a prior art advanced intelligent network (AIN);

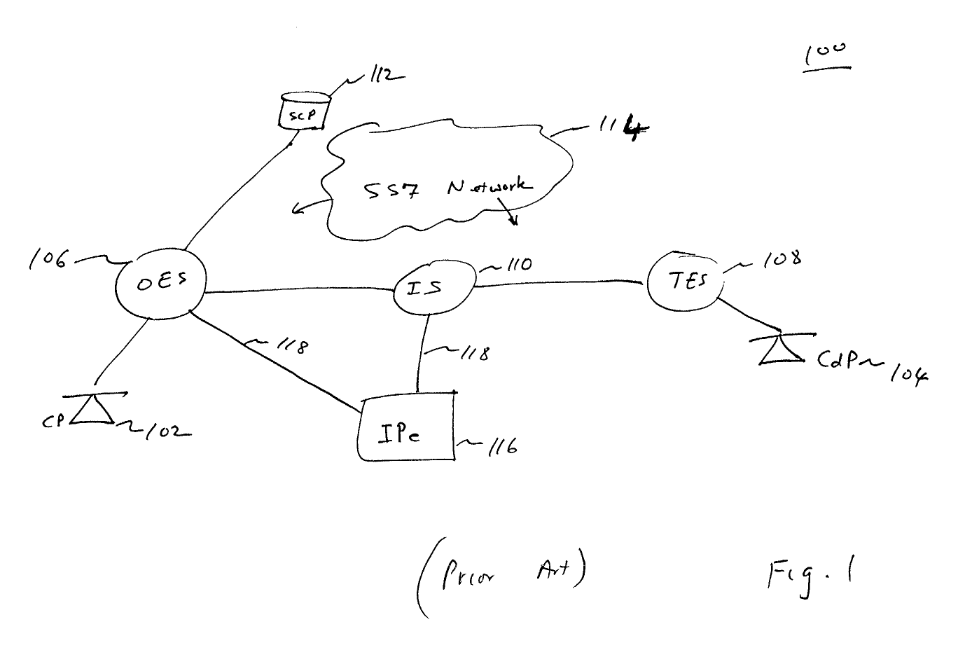

FIG. 2 shows a prior art call process using an Intelligent Peripheral;

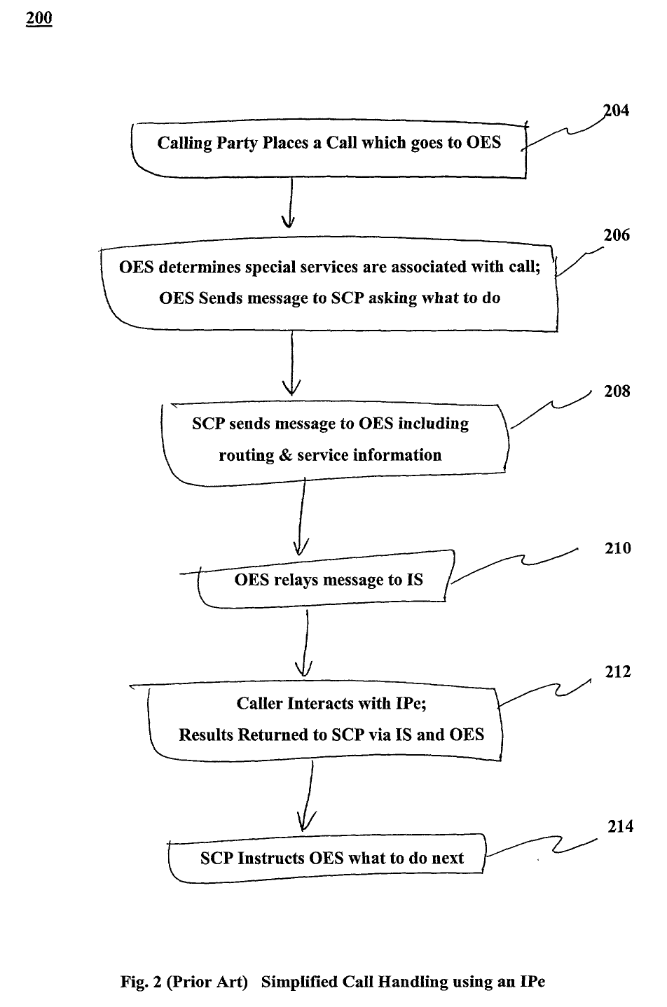

FIG. 3 shows a network in accordance with a first embodiment of the present invention;

FIG. 4 shows a network in accordance with a second embodiment of the present invention;

FIG. 5 shows a network with the call flow sequences indicated;

FIG. 6 illustrates the network of FIG. 5 after call merge;

FIG. 7a shows an exemplary Analyze_Route message, from the SCP to the OES, in accordance with the present invention;

FIG. 7b shows an exemplary ISUP LAM message, from the OES to the IS, in accordance with the present invention; and

FIG. 7c shows an exemplary Q.931 SETUP message, from the IS to the SN, in accordance with the present invention.

### DETAILED DESCRIPTION OF THE INVENTION

The present invention extends the concepts of Service Nodes (SNs) and Service Switching Points (SSPs) in an intelligent network. The present invention is described with reference to an intelligent network using SS7 signaling with a service node (SN) connected to network switches using ISDN PRI. It should be kept in mind, however, that the general principles of the claimed invention have applicability beyond these protocols.

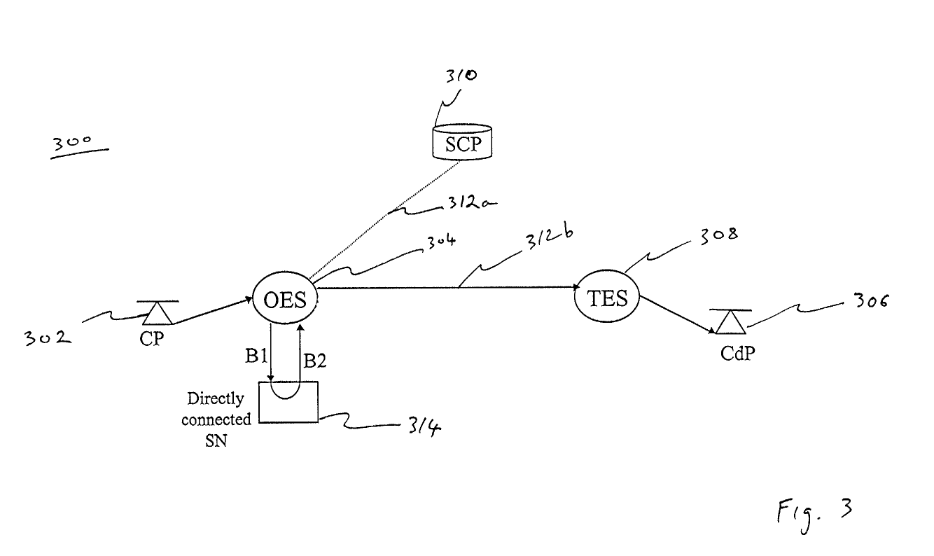

FIG. 3 shows a network 300 in accordance with a first embodiment of the present invention. In network 300, a calling party 302 is connected to an originating switch (OES) 304, and a called party 306 is connected to a terminating switch (TES) 308. The originating switch 304 is connected to an SCP 310 over an SS7 network link 312a using TCAP, as described above. The OES 304 is further connected to the TES over a SS7 network link 312b for the purpose of communicating signaling information. The switches communicate voice and/or data across a voice trunk (not shown). A service node (SN) 314 is connected to a hosting switch which, in the embodiment of FIG. 3, is the OES 304 directly connected to the SN 314. The hosting switch communicates with the SN 314 using N-ISDN PRI when the B1 and B2 legs are established during a call sequence.

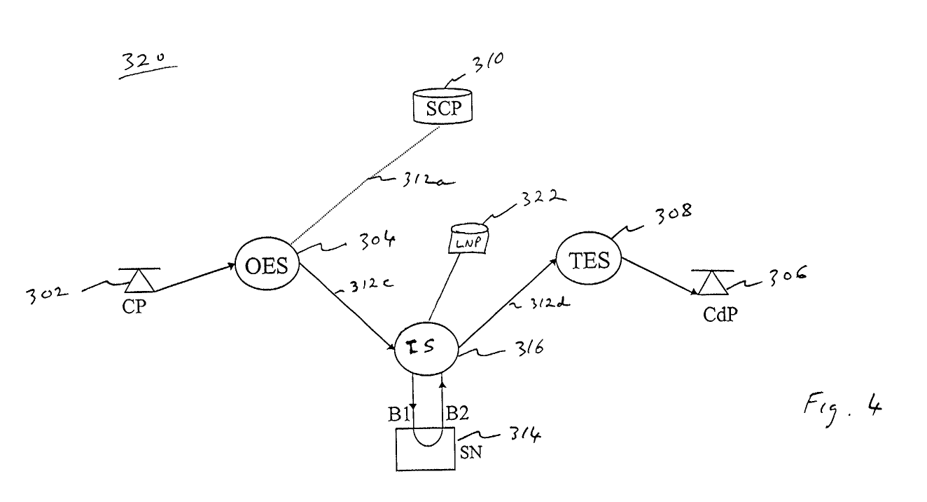

FIG. 4 shows a network 320 in accordance with a second embodiment of the present invention. In this embodiment, the SN 314 is hosted by an intermediate switch 316. As seen in FIG. 4, the intermediate switch 316 is connected to the OES 304 via link 312c and to the TES 308 via link 312d. It is understood, however, that the number of intermediate switches between the OES 304 and the TES 308 is not critical. And as also seen in network 320, the intermediate switch is also connected to a local number portability (LNP) database 322 to perform look-ups, as appropriate.

Customer and service-related information and data preferably reside in the SCP 310. The advantage of housing this information and data in the SCP is that it is most natural for the SCP to contain these. In this regard, it is noted that the SCP has already-defined support systems to provision information and so separate provisioning systems do not have to be created for the SN if the customer/service data resides in the SCP, especially when it has to be transported to the SN only as the SN needs it. This also allows a carrier greater flexibility in selecting a platform to host the SN.

The SN 314 serves as a node which can support certain services for a long distance carrier. Unlike a traditional IPe, however, the SN 314 is not under control of the SCP. And also unlike a conventional IPe, the SN can create billing information and perform call origination and call merging services, among others.

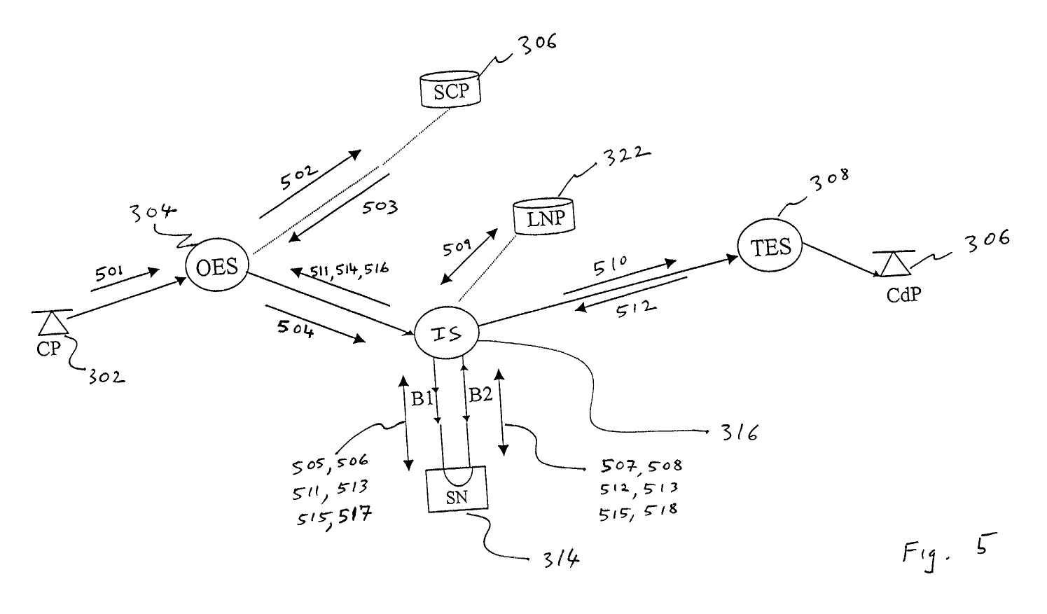

FIG. 5 presents a call flow diagram using the network 320 of FIG. 4, with the reference numerals adjacent to the arrow designating steps within the call flow sequence.

In step 501, Calling Party(CP) 302 dials a number associated with the called party CdP 306. The call is received by the OES 304.

In step 502, the OES 304 sends a query to the SCP 306. This query is either an: a) AIN Info_Collected message for encountering an Off-Hook-Delay (OHD) trigger, or b) AIN Info_Analyzed message upon encountering a Specific Digit String (SDS) trigger.

In step 503, the SCP sends a response back to the originating switch 304. The response includes the following: a) AIN Analyze_Route message which includes: (1) CalledPartyID parameter containing a routing number for the destination SN 314, which for example may be a Special Service Code type of number; and (2) an SNFlexBlock parameter which carries customer/service information from the SCP 310 to the SN 314 transparently through the OES 304; and b) an AIN Furnish_AMA_Information message with appropriate modules in the AMABAF Module parameter. The SNFlexblock itself includes a parameter ID for identification, a parameter length, and the content. The content may contain information such as announcement IDs that the SN can use to play announcements to calling and called parties via an IPe (not shown), and routing numbers which the SN can use to route a particular destination under certain conditions as per the service needs.

During step 504, when the OES 304 receives the SCP response, the OES examines the response and establishes a connection to the SN 314 (where PRI trunk OPTION=IPTRUNK). In general, an SN may be directly connected to the OES or may be hosted off of another ES (Edge Switch) termed a TES-SN (Terminating Edge Switch—Service Node; this is effectively an IS). For the case where the SN is not directly connected to OES, the OES first sends an ISUP IAM to IS 316.

In step 505, the IS 316 sends a Q.931 SETUP message to the SN 314 on the B1 leg. The following new information beyond the standard NISDN preferably also is passed to the SN at this time:

a) Calling Party Number (irrespective of presentation restriction setting);

b) Original dialed number (in addition to the routing number in the Called Party Number IE);

c) Billing number (a.k.a. automated number identification, or ‘ANI’) (in addition to the calling party number in the Calling Party Number IE);

d) Originating Line Information (OLI) (sent in Generic Digits CS6);

e) Information contained in the SNFlexBlock; and

f) Jurisdiction Information Parameter (JIP).

g) Optionally, an instruction from the SN for the host switch to suppress certain AIN triggers.

In step 506, the SN 314 sends the CALL PROCEEDING message to the IS 316 and the SN 314 executes the appropriate application, based on the 10-digit called party number received in the SETUP message.

In step 507, the SN 314 may be required to set up the B2 leg, if the application so requires. In such case, the SN sends a SETUP message to the IS 316. The information contained in the SETUP message may include one or more of the following:

a) Called Party Number, which may contain the original dialed number received from the B1 leg, or a routing number contained in the SNFlexBlock received from the B1 leg, or a routing number derived by the application in the SN;

b) Original dialed number received from the B1 leg;

c) Calling Party number received from the B1 leg;

d) Billing number received from the B1 leg;

e) Originating Line Information (OLI) received from the B1 leg; and

f) Jurisdiction Information Parameter (JIP) received from the B1 leg.

In step 508, the IS 316 sends the CALL PROCEEDING message to the SN after it receives the SETUP message. These SN trunks do not have the OHD trigger assigned and switch based AMA recording is turned off.

In step 509, the IS 316, on the B2 side of the call, performs an optional LNP query if the NPA-NXX of the Called Number is ported, and receives the response from the LNP database 322. If the number is ported, then appropriate LNP processing is done to route the call as per standard AIN LNP implementation. The Destination Location Routing Number (DLRN) is then saved until it is later sent to the SN, as discussed below in step 512.

In step 510, the IS 316 starts routing toward the called party 306 by sending an ISUP IAM to the TES 308.

In step 511, the SN may optionally send a PROGRESS message on the B1 leg before receiving a CONNECT, ALERTING or PROGRESS message from the B2 leg for basic user-network interaction with the caller (such as, play announcement & collect digit). If a PROGRESS message having Progress Indicator value of 8 (“In-band information or appropriate pattern now available”) is received from the SN, the IS 316 must initiate a two-way cut-through towards the calling party 302. This is achieved by sending an ISUP ACM with “Basic User-Network Interaction” encoding. This differentiated treatment can be achieved utilizing PRI trunk marking on the SN 314.

In step 512, the IS 316 receives the ISUP ACM or CPG from the terminating side. The IS 316 then sends the ALERTING message to the SN on the B2 leg. Preferably, the ALERTING message includes: (a) the DLRN and (b) a Terminating Access ID contained in the ISUP APP.

In step 513, if an ALERTING message is received by the SN 314 on the B2 leg, then it is sent to the B1 leg if ALERTING has not been sent earlier. Information contained in the ALERTING message sent by the SN to the IS on the B1 leg may include: (a) the DLRN received from the B2 leg; and (b) the terminating Access ID received from the B2 leg.

In step 514, the IS 316 receives the ALERTING message on the B1 leg and sends the corresponding ISUP message toward the OES 304 which then updates the AMA record with (a) the DLRN received from the B2 leg; and (b) the Terminating Access ID received from the B2 leg where the DLRN is supplied by the switch querying the LNP database and the terminating Access ID is supplied by the TES.

In step 515, if a CONNECT message is received by the SN 314 on the B2 leg, then the CONNECT message is sent on the B1 leg to the IS 316. The SN 314 then internally bridges the B2 and B1 legs so that parties can converse.

In step 516, the SN 314 may update the AMA record in the OES 304 on the B1 side by invoking supplementary service for adding AMA modules and/or updating existing fields in the AMA record. This is done indirectly by having the IS 316 transmit the request to update the AMA record in an ISUP message to the OES.

In step 517, the SN 314 may send/receive information of access significance. One example is the IS 316 could interwork these to an ISUP Access Transport Parameter (ATP) in an ISUP message.

In step 518, the SN may send subsequent SETUP messages to the IS 316 for sequence calls as per application needs with the original B2 call dropped.

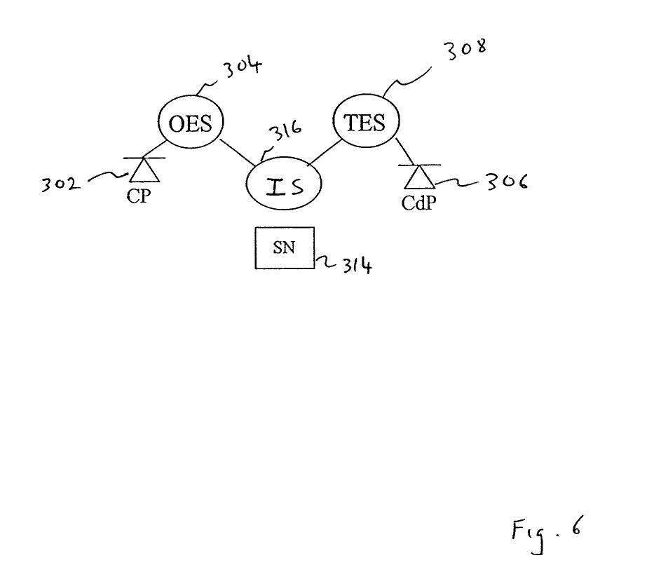

Finally, after the SN has provided its service, 2B Channel Call Transfer, as per GR-2865-CORE, takes place, thereby merging the call and freeing the SN, as depicted in FIG. 6. As seen in FIG. 6, the SN 314 is no longer connected to the IS 316, and is now free to be allocated to another call. Meanwhile, the calling party CP 302 is connected to the called party CdP 306 via the OES 304, the IS 316 and the TES 308.

The switch hosting the SN may have trunk group parameters that can be administered to indicate whether a given PRI trunk group is to a special, extended sort SN as indicated here, or the more limited SN as per prior art. If the former, then the host switch would cooperate in supporting the functionality for the extended SN as described; otherwise, it would not.

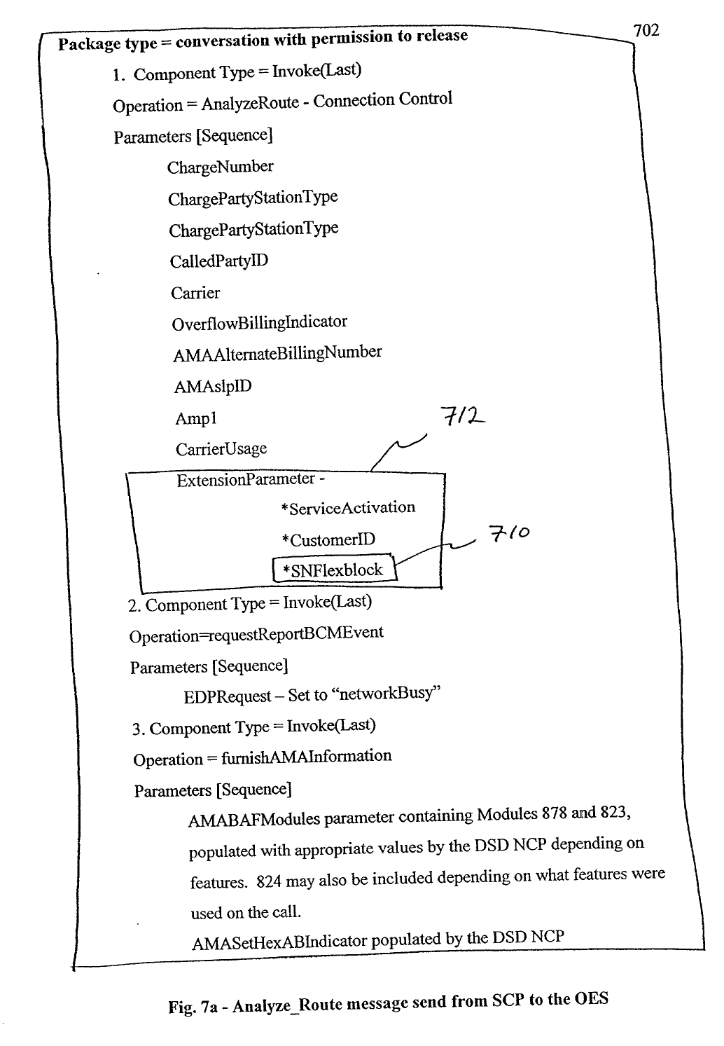

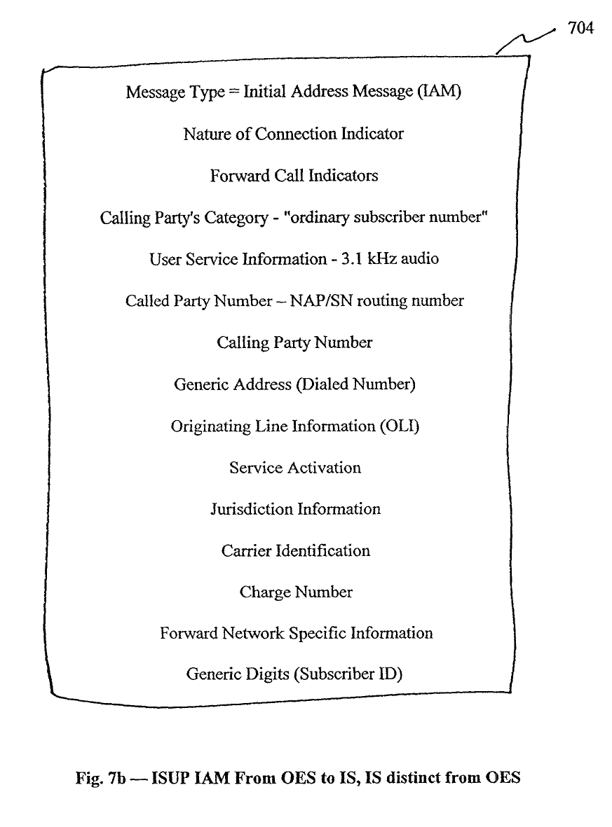

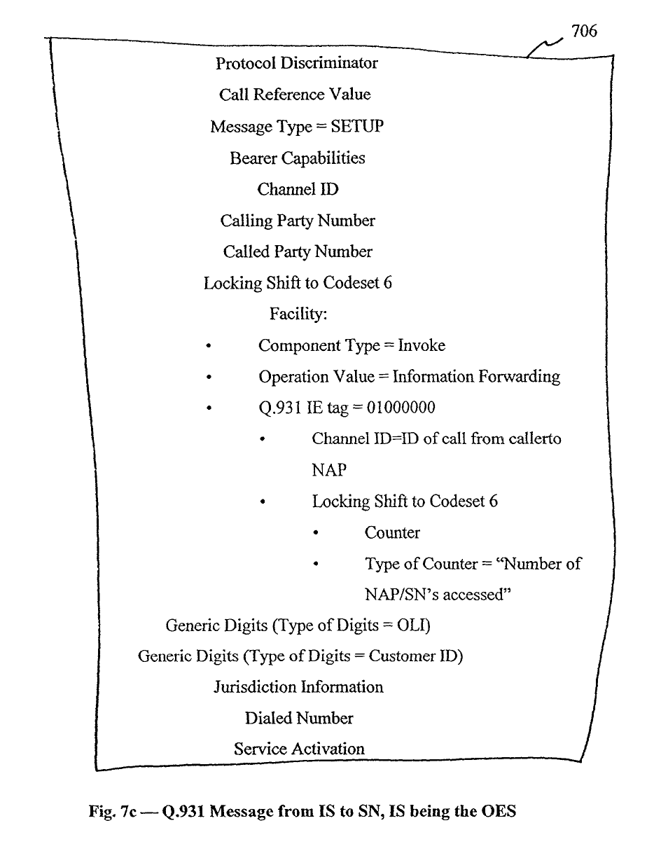

To implement the call flows presented in FIG. 5, one must make a number of software changes to the OES, SCP, and IS, in addition to properly configuring the SN. The required changes are implemented in the messaging protocols associated with the various platforms. In this regard, FIGS. 7a-7c show messages that are associated with the present invention. FIG. 7a depicts an Analyze_Route message 702, as modified in accordance with the present invention; FIG. 7b shows an exemplary ISUP IAM message 704 passed by the OES to the IS to establish the call, when the two are different switches; and FIG. 7c shows an exemplary Q.931 SETUP message 706 sent by the IS to the SN to establish the call, when the OES and the IS are the same. Importantly, the Analyze_Route message includes an “SNFlexblock” 710 in the Extension parameter set 712 of the Analyze_Route message.

Finally, while the above invention has been described with reference to certain preferred embodiments, it should be kept in mind that the scope of the present invention is not limited to these. One skilled in the art may find variations of these preferred embodiments which, nevertheless, fall within the spirit of the present invention, whose scope is defined by the claims set forth below.

What is claimed is:

1. A method of handling a telephone call in an intelligent network between a calling party and a called party, the intelligent network including at least one originating switch, a service control point (SCP) and a multi-function service node (SN) hosted by a hosting switch, the method comprising:
sending, from the originating switch to the SCP, a first query in response to a trigger condition encountered during processing of a call;
creating, at the SCP, a first response including a first parameter block comprising control information specific to services to which at least one of the calling and called party subscribes, and address information of the SN placed in a first field normally reserved for address information of the called party;
sending, from the SCP to the originating switch, the first response; and
sending, from the originating switch to the SN, at least the control information.

2. The method according to claim 1, wherein the hosting switch is the same as the originating switch.

3. The method according to claim 1, wherein the hosting switch is a switch other than the originating switch, but is connected thereto.

4. The method according to claim 1, wherein the first response includes address information of the called party placed in a second field.

5. The method according to claim 1, wherein the first response is an Analyze_Route response and the SN's address information is placed in a CalledPartyld parameter of the Analyze_Route response.

6. The method according to claim 1, comprising the steps of, at the originating switch, detecting a first parameter block intended for the SN and forwarding contents of the first parameter block intended for the SN to the SN.

7. The method according to claim 6, wherein the hosting switch is a switch other than the originating switch, and the originating switch forwards the control information to the hosting switch which forwards control information to the SN without first taking action pursuant to the control information.

8. The method according to claim 1, further comprising the step of, at the originating switch, updating an existing AMA record resident in the originating switch, based on billing information received from the SN.

9. The method according to claim 8, wherein the hosting switch is a switch other than the originating switch, and the SN sends the billing information to the OS via the hosting switch.

10. The method according to claim 1, wherein the control information is sent from the hosting switch to the SN using either an ISDN Q.931 Setup message or an ISUP IAM message.

11. The method according to claim 1, further comprising the steps of:
receiving, at the SN, a first call from the hosting switch on a B1 leg;
originating, from the SN, a second call on a B2 leg in response to the first call, and
transparently passing, through the SN, at least one parameter received on the B1 leg on to the B2 leg.
